(19) United States
(12) Patent Application Publication
(10) Pub. No.: US 2022/0314195 A1
(43) Pub. Date: Oct. 6, 2022

(54) METHOD FOR CREATING A LITHIUM ADSORBENT

(71) Applicant: EnBW Energie Baden-Württemberg AG, Karlsruhe (DE)

(72) Inventors: Thomas Kölbel, Karlsruhe (DE); Elif Kaymakci, Waldbronn (DE); Laura Herrmann, Karlsruhe (DE); Magdalena Graczyk-Zajac, Heidelberg (DE)

(73) Assignee: EnBW Energie Baden-Württemberg AG, Karlsruhe (DE)

(21) Appl. No.: 17/711,349

(22) Filed: Apr. 1, 2022

(30) Foreign Application Priority Data
Apr. 1, 2021 (DE) 10 2021 108 442.3

(51) Int. Cl. B01J 20/04; B01J 20/30

(52) U.S. Cl. CPC B01J 20/041; B01J 20/3078; B01J 20/3071; B01J 2220/4806

(57) ABSTRACT

The present invention relates to a method for creating a lithium adsorbent.

### BACKGROUND

The present invention relates to a method for creating a lithium adsorbent.

Due to its advantages, such as high electrical energy density, high operational voltage, a long cyclical service life, lack of memory effect, etc., the rechargeable lithium ion battery (more precisely: lithium ion accumulator) is commonly used in notebook computers, mobile phones, and electric cars. The demand for lithium ion accumulators is growing rapidly, especially as electric mobility becomes more common.

Furthermore, various lithium compounds are used, e.g., in the ceramic and glass industries, aluminum electrolysis, and the manufacture of synthetic rubber. Lithium carbonate is the lithium compound with the highest demand.

Currently there are two main natural resources that are used to manufacture lithium salts, specifically lithium ore and brine. The term “brine”, in relation to this invention, concerns any watery solution containing lithium ions. Groundwater, deep water, seawater and the “waste products” of seawater desalination facilities are referred to as “brine” with regard to this invention.

In order to be able to produce lithium salts from a brine containing only few lithium ions (typically 10 to 1000 mg/L), the concentration thereof should be 15,000 ppm or greater. There is thus great interest in developing a process for increasing the lithium-ion concentration of the brine to a level required for the production of lithium salts.

Adsorption methods, which allow an eluent to be obtained with a lithium concentration of around 1,500 ppm from an aqueous solution (brine) that contains lithium, are known from U.S. Pat. No. 6,764,584 B2 and the subsequently published DE 10 2021 105 808.2 (filing date 10 Mar. 2021).

These previously known adsorption methods work very well. The adsorbent H_{1.6}Mn_{1.6}O₄ is used. It is dissolved partially when the lithium ions are desorbed with a liquid eluent (so-called dissolution) and is thereafter no longer available for further adsorption. Due to the dissolution, the adsorbent must be supplemented or replaced at regular intervals. The cost of the adsorbent has a significant effect on the economic viability of the adsorption process.

From CN 103 272554 A, a method for producing a lithium manganese oxide-type of lithium adsorbent (hereinafter adsorbent) is known. This previously known method comprises the following steps:

1) Adding a lithium source and a manganese source to an aqueous solution which contains a complexing agent and an oxidizing agent and stirring it for 1 to 72 hours at a constant temperature of 20 to 120° C. to obtain LiMnO₂, an intermediate product;

2) Calcining the intermediate product LiMnO₂ in air for 1 to 24 hours at a temperature of 300 to 1000° C. to obtain Li_{1.6}Mn_{1.6}O₄, a precursor;

3) Eluting the precursor Li_{1.6}Mn_{1.6}O₄ using an inorganic acid, namely hydrochloric acid (HCl), and

4) then filtering, washing and drying to obtain the lithium adsorbent H_{1.6}Mn_{1.6}O₄.

This method is simple and relatively inexpensive.

### SUMMARY OF THE INVENTION

The object of the invention is to further improve the method known from CN 103 272554 A for creating an adsorbent.

This object is accomplished according to the invention by means of a method for creating the lithium adsorbent according to claim 1.

The method according to the invention shows similarities to the method known from CN 103 272554 A. However, according to the invention, acetic acid, sodium peroxodisulfate and/or ammonium peroxodisulfate is used as an eluent of the precursor Li_{1.6}Mn_{1.6}O₄ in step 3).

The use of the eluents according to the invention shows a significantly lower release of manganese relative to the hydrochloric acid from the adsorbent. As a result, compared to hydrochloric acid, the adsorbent can be used for longer and in several cycles. At the same time, the adsorbent treated with acetic acid, ammonium peroxodisulfate and sodium peroxodisulfate contains fewer impurities and therefore performs better.

These advantages together not only improve the product and process performance in specific use, but at the same time mean lower energy consumption in the production of the adsorbent relative to the adsorption rate.

The same also applies to the step according to claim 2. According to the same, the intermediate product, lithium manganese dioxide is produced in an autoclave from a manganese precursor (=a substance which contains manganese) and a lithium precursor (a substance which contains lithium).

It has proved to be particularly advantageous if the hydrothermal synthesis in the autoclave takes place under pressure, with the pressure being in a range of 10 bar and 200 bar. A pressure range of 20 bar to 50 bar is particularly preferred. This further improves the performance, duration, and efficiency of the hydrothermal synthesis.

The precursor, dimanganese trioxide Mn₂O₃, is produced by means of calcination from manganese dioxide (MnO₂). The calcination of the precursor according to claim 3 should preferably occur at a temperature of about 650° C. and last about six hours.

Then the hydrothermal synthesis takes place. The intermediate product, LiMnO₂, is obtained from the manganese precursor (preferably Mn₂O₃) and the lithium precursor. The hydrothermal synthesis preferably takes place at 120° C. for 24 hours at an elevated pressure. The intermediate product, lithium manganese dioxide LiMnO₂, is calcined in an oxidative environment, producing the sorbent precursor, Li_{1.6}Mn_{1.6}O₄. Based on extensive testing, it was determined that the calcination of the intermediate product, lithium manganese dioxide (step A in claim 1) should take place in a temperature range of 350° C. to 1000° C., and in particular, preferably at around 400° C.

If the calcination takes between one to twenty hours, preferably four hours, the results obtained are very good with a relatively shorter process duration at the same time and comparatively low energy consumption.

The hydrothermal synthesis of the intermediate product, lithium manganese dioxide, preferably takes place at a temperature of about 100 to 200° C., preferably 120° C., while the pressure is significantly higher in comparison to other methods, and lasts about 24 hours. In this case, too, these parameters have proved to be suitable; particularly with regard to high efficiency during the synthesis with relatively low energy consumption at the same time.

The calcination of the precursor according to claim 4 should preferably take place at a temperature of about 650° C. and last about six hours.

### BRIEF DESCRIPTION OF THE DRAWINGS

Further advantages and advantageous embodiments of the invention can be seen in the following drawing and its description. All the characteristics disclosed in the FIGURE, its description and the patent claims are fundamental to the invention, both individually as well as in any combination with each other.

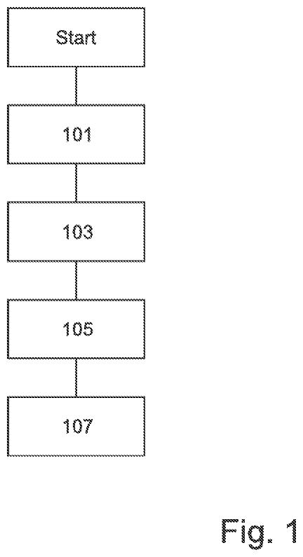

The single FIG. 1 shows the method according to the invention for creating an adsorbent in the form of a block diagram. The method begins with the starting product, manganese dioxide MnO₂ In the first step (block 101), this starting product is calcined, preferably at a temperature of about 650° C. and over a duration of about six hours. The calcination results in the production of a precursor, dimanganese trioxide Mn₂O₃.

### DETAILED DESCRIPTION

This precursor is placed in an autoclave together with lithium precursors (preferred) LiOH (block 103). Lithium manganese dioxide LiMnO₂ is produced in it through hydrothermal synthesis. A temperature of about 120° C. and a duration of 24 hours have proved to be suitable process parameters. It is also beneficial if the hydrothermal synthesis occurs at pressures of 10 bar or higher.

In a further step (block 105), this lithium manganese dioxide is calcined, preferably at a temperature of 400° C. and for a duration of four hours. This results in the precursor Li_{1.6}Mn_{1.6}O₄ of the adsorbent.

In a subsequent step (block 107), this precursor is washed with acetic acid, sodium peroxodisulfate and/or ammonium peroxodisulfate.

It is also possible to use these acids in diluted form rather than in pure form. The mixture of the eluent or a solution

that contains the abovementioned eluents could also be used. The following mixing ratios have proved to be suitable:

If acetic acid is used, the proportion of acetic acid in the solution is between 0.1% and 100%.

If sodium peroxodisulfate is used, this proportion is preferably between 0.05% and 65%; if ammonium peroxodisulfate is used, this proportion is between 0.05% and 65%.

The liquid is then filtered to separate the adsorbent which has the form of a granular sub stance.

This adsorbent is then washed with distilled water and dried. This results in the desired adsorbent H_{1.6}Mn_{1.6}O₄ which can be used in an adsorption column to increase the concentration or to obtain lithium ions.

1. Method for creating the lithium adsorbent H_{1.6}Mn_{1.6}O₄ comprising the following steps:
a. Calcining an intermediate product LiMnO₂ in air to obtain the precursor Li_{1.6}Mn_{1.6}O₄;
b. Eluting the precursor Li_{1.6}Mn_{1.6}O₄ using acetic acid (CH₃COOH), sodium peroxodisulfate (Na₂S₂O₈)) and/or ammonium peroxodisulfate ((NH₄)₂S₂O₈) or a mixture of the above-mentioned eluents/a solution which contains the above-mentioned eluents and
c. then separating, washing with distilled water and drying to obtain the lithium adsorbent H_{1.6}Mn_{1.6}O₄.

2. Method according to claim 1, characterized in that the intermediate product LiMnO₂ is produced by means of hydrothermal synthesis in an autoclave from a precursor, dimanganese trioxide (M₂nO₃) and LiOH.

3. Method according to claim 2, characterized in that the hydrothermal synthesis occurs in the autoclave under pressure in a pressure range of 10 bar and 200 bar.

4. Method according to claim 2, characterized in that the precursor, dimanganese trioxide (M₂nO₃), is produced from manganese dioxide (MnO₂) through calcination.

5. Method according to claim 2, characterized in that the calcination of the intermediate product, LiMnO₂, (step a) in claim 1) occurs at a temperature of 350° C. to 1000° C., preferably at 400° C., and/or that the calcination lasts for 3 hours to 5 hours, preferably 4 hours.

6. Method according to claim 2, characterized in that the intermediate product, LiMnO₂, is produced from a precursor, dimanganese trioxide (M₂nO₃) and LiOH, at an elevated pressure and/or a temperature of about 100 to 200° C., preferably at 120° C., and/or that the hydrothermal synthesis lasts about 24 hours.

7. Method according to claim 4, characterized in that the calcination of the precursor, dimanganese trioxide (M₂nO₃) takes place at a temperature of about 650° C., and/or lasts six hours.
